(19) United States
(12) Patent Application Publication
(10) Pub. No.: US 2006/0124425 A1
(43) Pub. Date: Jun. 15, 2006

(54) Planar coupling assembly

(75) Inventors: Robert D. Fetting JR., Caro, MI (US); Gregory M. Eisengruber, Saginaw, MI (US)

Correspondence Address: BROOKS KUSHMAN P.C., 1000 TOWN CENTER, TWENTY-SECOND FLOOR, SOUTHFIELD, MI, 48075, US

(73) Assignee: Means Industries, Inc., Saginaw, MI (US)

(21) Appl. No.: 11/008,303

(22) Filed: Dec. 9, 2004

(51) Int. Cl. F16D 47/04

(52) U.S. Cl. 192/48.3; 192/46; 192/48.92

(57) ABSTRACT

A planar overrunning coupling for a geared transmission. The coupling has a circular pocket plate, a notch plate, and torque transmitting struts in pockets formed in the pocket plate. The notch plate has a snap ring groove that receives a snap ring, the geometry of the snap ring resisting disassembly of the coupling without the use of a special tool.

### CROSS-REFERENCE TO RELATED APPLICATION

This application relates to co-pending U.S. application Ser. No. 10/869,583 filed Jun. 16, 2004, which is assigned to the assignee of this application.

### BACKGROUND OF THE INVENTION

1. Field of the Invention

The invention relates to a planar coupling, including a snap ring for maintaining the elements of the coupling in assembled relationship.

2. Background Art

Planar couplings are disclosed in prior art U.S. Pat. Nos. 5,964,331 and 5,597,057, which are assigned to the assignee of the present invention. Another example of a planar coupling is disclosed in the co-pending patent application identified above.

The planar couplings disclosed in the '337 patent and '057 patent, as well as in the co-pending patent application identified above, include a pocket plate provided with angularly spaced recesses or pockets about the axis of the coupling. The pockets are formed in a planar surface of the pocket plate. Each pocket receives a torque transmitting strut, one end of which engages an anchor point in a pocket of the pocket plate. An opposite end of each strut, which hereinafter may be referred to as an active edge, is movable from a position within the pocket to a position in which the active edge extends outwardly from the planar surface of the pocket plate. Each strut is biased away from the pocket plate by a spring.

A notch plate of the coupling is formed with a plurality of recesses or notches located approximately on the radius of the pockets of the pocket plate. The notches are formed in the planar surface of the notch plate.

The coupling of the co-pending patent application transfers reaction torque on the carrier of one of several planetary gear units within a multiple ratio geared transmission for an automotive vehicle powertrain. The coupling is secured in a fixed fashion within the transmission housing and held in place by a common snap ring and snap ring groove. A second snap ring secures the pocket plate within the notch plate. The struts and the springs that bias the struts into engagement with the pocket plate are enveloped within a space between juxtaposed planar surfaces of the notch plate and the pocket plate. The snap ring that maintains the pocket plate and the notch plate in assembled relationship permits the coupling to be installed in the transmission housing during a transmission assembly procedure.

The coupling itself is preassembled to form a separate subassembly that can be installed during the transmission assembly procedure. If the snap ring that secures together the pocket plate and the notch plate in assembled relationship is removed for any reason by the transmission installer, or if it is removed for servicing the transmission, the pocket plate and the notch plate will become separated and the struts and the springs enveloped by the notch plate and the pocket plate will fall within the transmission gearing elements and other moving elements of the transmission. This presents a serious maintenance and service problem.

### SUMMARY OF THE INVENTION

The coupling of the present invention includes, as part of a coupling assembly, a snap ring that will prevent its inadvertent removal from the coupling assembly thereby avoiding the service problem identified in the preceding discussion. The snap ring is adapted to be received in a snap ring groove in the inside diameter of the notch plate, which overlies the outside diameter of the pocket plate. When the snap ring is secured within the snap ring groove in the notch plate, separation of the notch plate and the pocket plate is avoided, and undesirable disbursal of the struts and the springs in the space between the planar surfaces of the notch plate and the pocket plate is avoided. Further, the struts and springs are isolated from the transmission gearing.

The snap ring comprises an annular plate that is split to form two open ends. The ends of the snap ring may be generally radial with respect to the axis of the coupling. It can be assembled within the snap ring groove merely by flexing the snap ring to reduce its outside diameter so that it fits within the inside diameter of the notch plate. When the snap ring is in registry with the snap ring groove in the notch plate, its outside perimeter will snap into place within the notch plate groove. The tip of one of the snap ring ends is notched to accommodate an end of a hand tool designed specifically to effect removal of the snap ring from its snap ring groove. The notch is located in the tip of one end of the snap ring at a location that is greater than the inside diameter of the snap ring groove in the notch plate, which in turn is splined or otherwise secured to the transmission housing.

The strategic geometry of the snap ring prevents inadvertent removal of the snap ring during servicing of the transmission. If removal of the coupling assembly is required during servicing, the entire coupling assembly can be removed readily by removing a conventional snap ring that secures the notch plate against axial movement with respect to the housing. The coupling then is removed as a complete subassembly and it can be reinstalled as a complete subassembly with the notch plate and the pocket plate, together with the struts and the springs, intact.

### BRIEF DESCRIPTION OF THE DRAWINGS

FIG. 1 is a partial cross-sectional view of a gearing system that includes the planar one-way coupling of the invention in combination with two friction clutch assemblies;

FIG. 2a is an enlarged detail view of a portion of the cross-sectional view of FIG. 1 wherein the elements of the planar one-way coupling of the invention are emphasized;

FIG. 2b is a plan view of a snap ring used with the coupling assembly of FIGS. 1 and 2a;

FIG. 2c is a partial edge view of the snap ring of FIG. 2b together with a portion of the notch plate that surrounds the pocket plate;

FIG. 2d is a partial plan view of the snap ring of FIG. 2b together with a tool designed to release the snap ring from its snap ring groove;

FIG. 2e is a view similar to the view of FIG. 2d showing the snap ring displaced radially inward of its end by a hand tool to effect removal of the snap ring from its snap ring groove;

FIG. 3a is an isometric view of a pocket plate, which forms an element of the planar one-way clutch assembly of the invention;

FIG. 3b is an isometric view of a notch plate for use with the pocket plate of FIG. 3a in the assembly of FIG. 2;

FIG. 3c is an isometric view of a torque transmitting strut located in a pocket of the pocket plate of FIG. 3a;

FIG. 3d is a cross-sectional view of one of the pockets of the pocket plate of FIG. 3a as seen from the plane of section line 3d-3d of FIG. 3a;

FIG. 4 is a plan view of the planar surface of the pocket plate of FIGS. 1, 2 and 3a;

FIG. 5 is a plan view of the planar surface of the notch plate of FIGS. 1, 2 and 3b;

FIG. 6 is a cross-sectional view of the pocket plate of FIG. 4 as seen from the plane of section line 6-6 of FIG. 4; and

FIG. 7 is a cross-sectional view of a pocket plate similar to the pocket plate disclosed in prior art U.S. Pat. No. 5,964,331, wherein a positive draft angle is present at a radially outward wall of the pocket.

### DETAILED DESCRIPTION OF THE PREFERRED EMBODIMENTS

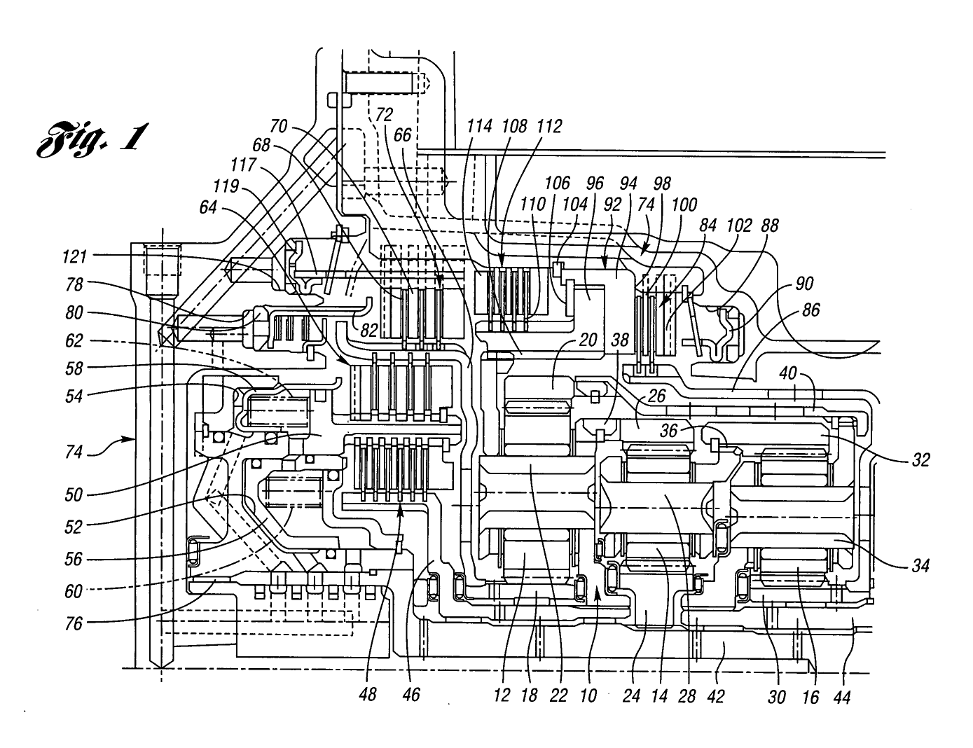

An automatic transmission gear system is shown in the partial cross-sectional view of FIG. 1. It includes a planetary gearing arrangement 10, which comprises three simple planetary gear units 12, 14, and 16. Gear unit 12 includes a sun gear 18, a ring gear 20, and a planetary carrier 22. Gear unit 14 comprises a sun gear 24, a ring gear 26, and a planetary carrier 28. Gear unit 16 comprises a sun gear 30, a ring gear 32, and a planetary carrier 34.

Carrier 28 is drivably connected to sun gear 32, as shown at 36. Carrier 22 is drivably connected to ring gear 26, as shown at 38. Ring gear 20 is drivably connected to planetary carrier 34 by a torque transfer member 40.

A torque input shaft, which corresponds to the turbine shaft of a hydrokinetic torque converter (not shown), is designated by reference numeral 42. It is splined to sun gear 24. Torque output sleeve shaft 44 is splined to carrier 34, and carrier 22 is splined to friction clutch element 46 of a multiple disc clutch assembly 48, which is engaged during operation of the transmission in the fourth, fifth and sixth speed ratio.

Clutch plates register with clutch discs of the clutch assembly 48. Clutch plates are connected to clutch member 50, which defines in part spaced annular clutch cylinders, as shown at 52 and 54. An annular piston 56 is disposed in clutch cylinder 52 and an annular piston 58 is disposed in annular cylinder 54. The pistons 56 and 58 are biased to a clutch release position by clutch return springs 60 and 62, respectively. The cylinder 52 and the piston 56 define a pressure chamber, which, when pressurized causes piston 56 to frictionally engage the clutch plates and clutch discs of the multiple disc clutch assembly 48 to establish a driving connection between carrier 22 and clutch element 50.

Internally splined clutch plates of a multiple disc clutch assembly 64 are splined to the clutch element 50. Externally splined clutch plates of multiple disc clutch assembly 64 are drivably connected to sun gear 18 by clutch element 66.

Clutch element 66 is connected drivably to friction brake discs 68, which register with friction plates 70 of a multiple disc brake assembly 72.

Clutch disc assembly 64 is engaged during operation in the third and fifth speed ratio, as well as in reverse drive. Brake disc assembly 72 is engaged during operation in second ratio and sixth ratio.

The stationary transmission housing 74 rotatably supports turbine shaft 42, as shown at 76. Housing 74 defines an annular brake pressure chamber 78 in which is situated annular piston 80. A brake actuator element 82 carried by the piston 80 is engageable with the brake disc assembly 72 to establish a torque reaction point for sun gear 18.

Sun gear 16 is drivably connected to brake disc assembly 84 by means of torque transfer element 86. Housing 74 defines an annular cylinder 88, which receives annular piston 90.

The planar coupling of the invention is illustrated in FIG. 1 at 92. It comprises a notch plate 94, which envelopes pocket plate 96. The planar annular surface 98 provides a brake disc reaction surface, which is engaged by an adjacent brake disc of the brake disc assembly 84. Clutch plates of the brake disc assembly 84 are externally splined to the transmission housing 74, as shown at 100.

The brake disc assembly 84 is frictionally engaged when pressure is applied to the piston 90, which actuates pressure plate 102 of the brake disc assembly 84.

The notch plate 94 acts as the reaction element for the brake disc assembly 84. It is splined to the transmission housing 74 and is secured within the transmission housing against axial displacement by snap ring 104 located in a snap ring groove in the transmission housing 74.

The pocket plate 96 is held fast within the notch plate 94 by a snap ring 106 situated in a snap ring groove formed in the pocket plate 94.

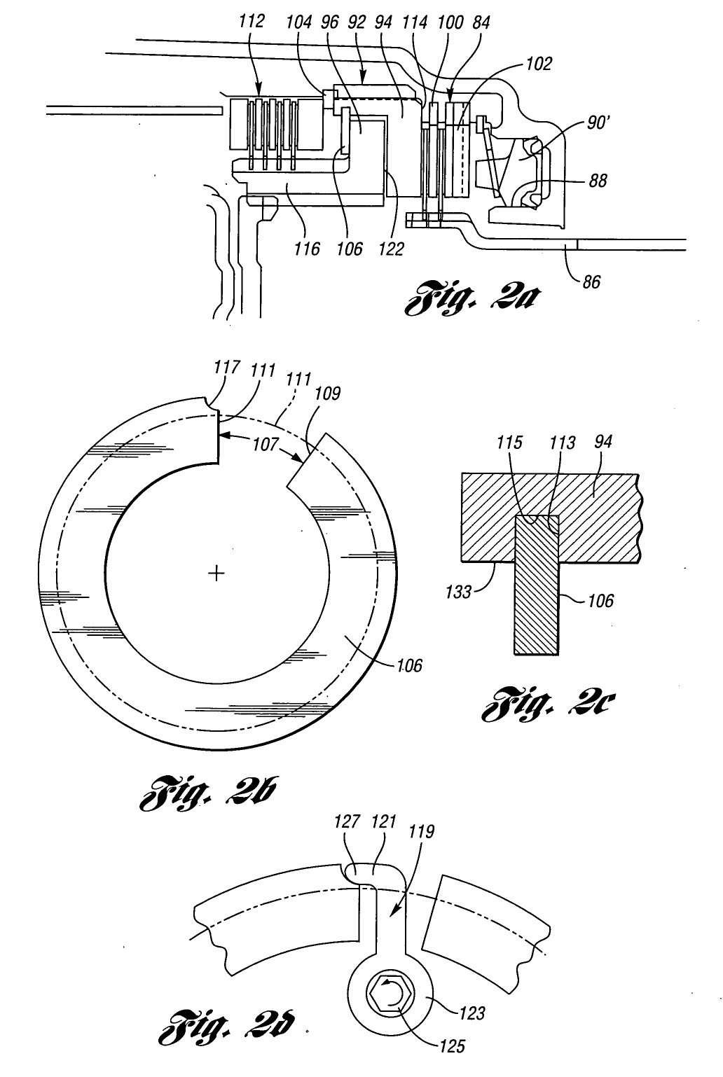

The snap ring 106 is a plate-type annular snap ring with an arcuate gap or opening 107, which defines a pair of snap ring ends 109 and 111. As seen in FIG. 2c, the snap ring 106, when it is assembled, is disposed in an annular snap ring groove 113 in notch plate 94, which extends axially, as mentioned previously, over pocket plate 96. The root diameter of groove 113 is shown at 115 in FIGS. 2c.

As seen in FIG. 2b, a radially outward tip of the snap ring 106, at the end 111, is formed with a notch 135. The notch is located substantially radially outward of the inside diameter 133 for the notch plate 94. Because of the geometry of the snap ring 106, it is very difficult to remove the snap ring 106 from its assembled position thereby avoiding inadvertent disassembly of the coupling during either servicing or assembly of the transmission.

In order to remove the snap ring 106 from the groove 113, a special tool is required, as shown in FIGS. 2d and 2e. The tool is indicated generally by reference numeral 129. The tool 129 comprises an arm 131, which extends through the arcuate opening 107 between the snap ring ends 109 and 111. Radially inward of the snap ring is a tool body portion 123, which carries a tool adapter, such as a hexhead 125, that is sized for registry with a hand socket tool that will permit the arm 131 to be rotated in a counter-clockwise direction, as seen in FIGS. 2d and 2e. Although the body 123 is shown in FIGS. 2d and 2e with a hexhead, other head geometries could be used, such as a square head or a slotted head to permit rotation of the arm 131 by torquing a hand tool, such as a wrench or a screwdriver. The head may also be recessed to permit entry of a Phillips head screwdriver.

When the arm 131 is positioned through the opening 107 into the snap ring groove 113, an end hook 127 on the arm 131 will enter the notch 135, as shown in FIG. 2d. As torque is applied to the body 123, the arm 131 will engage the inner tip 129 of snap ring end 109, as shown in FIG. 2e. The leverage provided by the fulcrum action at 129 will allow the hand tool to move the snap ring end 111 radially inward, as shown in FIG. 2e. The dotted line position indicated at 131 is the original position of the snap ring end 111 when the snap ring 106 is in place in the snap ring groove. The full line position of the snap ring end 111 is the position that the end 111 assumes after torque is applied to the hand tool. The end 111 can be moved radially inward in this fashion until the outside diameter of the snap ring at the snap ring end 111 becomes less than the inside diameter 133 for the notch plate 94.

Pocket plate 96 has an axial extension 116, best seen in FIG. 2a, which is externally splined to internally splined friction brake discs 110 of a multiple disc brake assembly 112. Splined clutch plates are connected to transmission housing 74, seen in FIG. 1. Brake pressure plate 114 is engaged by an actuator element 117, which in turn is carried by brake actuator piston 118. The pocket plate extension 116 has internal splines 108 to establish a splined driving connection to carrier 22, as best seen in FIG. 1.

An annular cylinder 121 formed in the transmission housing 74 receives a piston 119. Internal fluid pressure passages provide actuating pressure to the cylinder 121 to create a brake actuating force on the piston 119. That force is transmitted through the actuator element 117, which engages pressure plate 114 to apply the brake disc assembly 112. This anchors the carrier 22 of the planetary gear unit 12.

FIG. 2a is an enlarged detail view of the planar clutch assembly 92 and the friction brake assembly 84. The piston 90′ of FIG. 2 corresponds to the piston 90 of FIG. 1, the later being formed as a steel stamping whereas the piston 90′ is a machined part. In each instance, when the piston or the multiple disc brake assembly 84 is subjected to brake actuating pressure, a force is applied to the pressure plate 102. The reaction for that actuating force on the pressure plate is accommodated by the notch plate 94. The reaction force is transmitted to the transmission housing through snap ring 104.

The surface 98 on the notch plate is fully precision ground prior to assembly so that it can act as a backing plate for the friction disc pack. It thus is not necessary with the design illustrated in FIGS. 1 and 2 to provide a separate backup plate for the friction brake assembly. The integrated design illustrated in FIGS. 1 and 2 incorporates common features for the planar coupling 92 and the friction brake assembly 84, thereby eliminating components and reducing the packaging space for the torque transmitting elements of the transmission.

As previously mentioned, the brake disc assembly 84 is applied during operation in the first, second, third and fourth speed ratios for the transmission. This provides a coast braking torque for the transmission during forward drive. Reaction torque is transmitted from the sun gear 30 and from the torque transfer element 86 through the engaged brake disc assembly 84. During forward drive, reaction torque on the sun gear 30 is accommodated by the planar coupling 92.

When the planar coupling is active, forward driving torque is transmitted from the carrier 22 to the transmission housing through the pocket plate during first, second, third and fourth gear ratio operation. When the transmission is operating in the fifth and sixth speed ratio, pocket plate 96 will assume a freewheeling condition whereby the pocket plate will overrun the stationary notch plate. Coast braking during low speed ratio operation and reverse drive operation can be achieved by engaging multiple disc brake assembly 112, which includes friction brake discs 110 that are splined to extension 116 on the pocket plate 96.

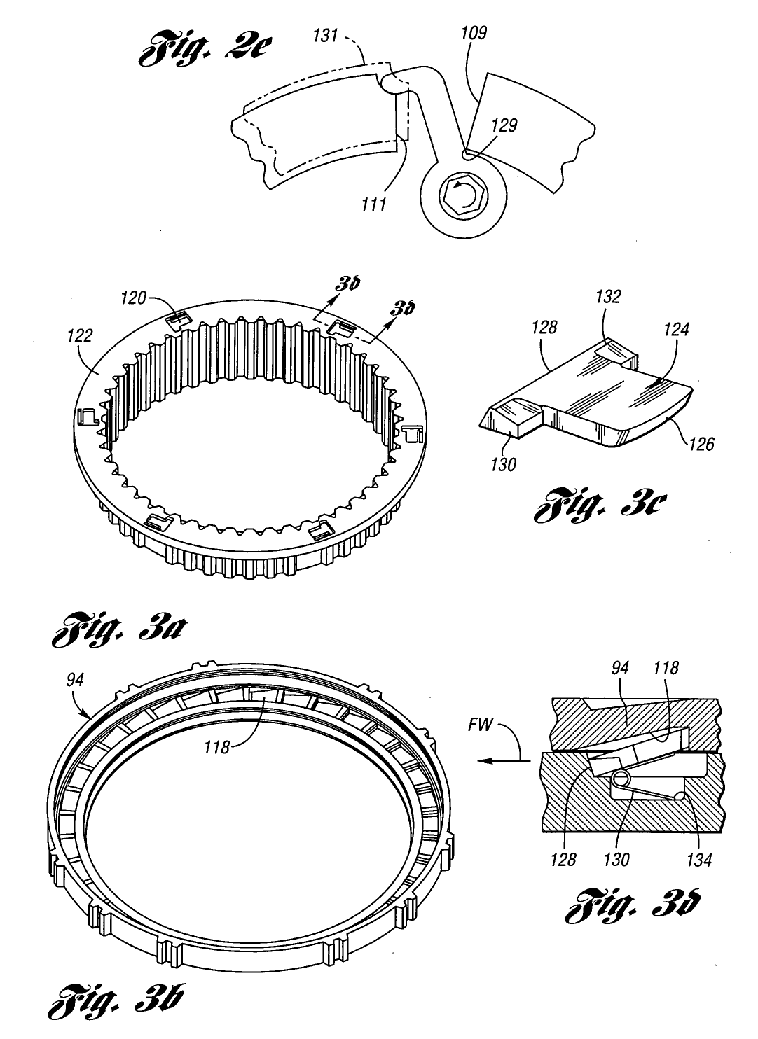

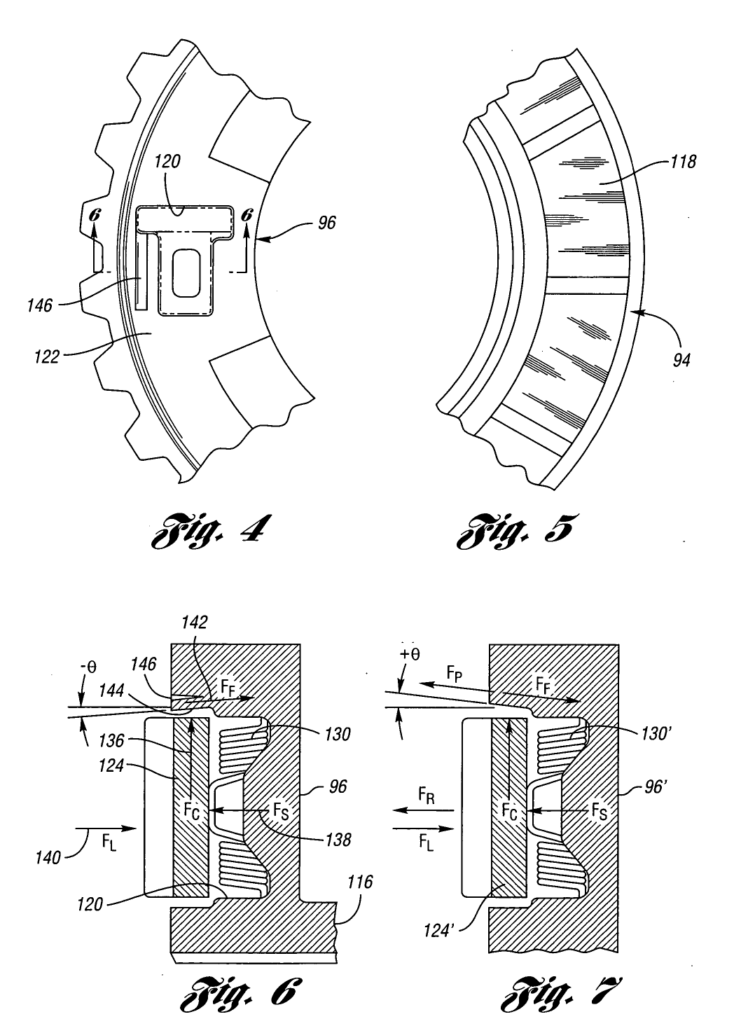

The stationary externally splined notch plate 94, as best seen in FIG. 3b and in FIG. 5, includes a plurality of ramped recesses or notches 118, seen in FIGS. 3d and 5, throughout the entire periphery of the notch plate. These notches are situated in juxtaposed adjacent relationship with respect to pockets 120 formed in the planar annular surface 122 of the pocket plate, as seen in FIGS. 2a and 4. The pockets 120 are disposed about the periphery of the pocket plate, as seen in FIG. 3a.

A torque transmitting strut 124 is situated in each pocket. The struts are best seen in FIGS. 3c and 6. They include a notch engaging active edge 126 and an anchor edge 128. The edge 128 is elongated in a tangential direction to provide anchor shoulders 132 and 132′, which are received in a radially enlarged portion of the pockets 120.

FIG. 3d shows the anchor edge 128 engaged with one edge of the pocket 120. A spring, preferably a leaf-type or hairpin-type spring, as shown in FIGS. 3d and 6 at 130, is supported by a base surface 134 of the pocket 120. The spring engages the underside of the torque transmitting strut 124, as best seen in FIGS. 3d and 6, and urges the strut 124 in a radially outward direction. This causes the strut to pivot about anchor edge 128. The active notch plate engaging edge 126 is moved outwardly so that it is engageable with the notches 118 as the pocket plate moves rotatably relative to the notch plate.

The number of pockets may be different than the number of pockets to reduce backlash. They may be arranged relative to the pockets to effect multiple strut engagements, thereby increasing coupling torque capacity.

When the pocket plate moves rotatably in the direction of the directional vector FW in FIG. 3d, the torque transmitting strut 126 will ratchet across the notches 118. If the relative motion of the pocket plate is zero, the notch plate engaging active edge 126 of the struts 124 will engage an edge of the notches 118 thereby preventing reverse motion of the pocket plate relative to the notch plate.

The radially outward edge of the pocket 120, as seen in FIGS. 4 and 6 is displaced or coined at 146 to provide a negative draft angle (−θ) at 144 to retain the strut 124 and to develop a strut retaining force component F_{F} developed by centrifugal force F_{C}. This is in contrast to a conventional draft angle (+θ) for the design of FIG. 7.

The elements of the design of FIG. 7 have corresponding elements in the design of FIG. 6 and they are identified by corresponding reference numerals although prime notations are added. Force F_{C} represents a minor force created by fluid pressure as transmission fluid is displaced by a moving strut. Force F_{R} is the combined force F_{S} of the spring and the strut “push-out” force component F_{P}.

Although an embodiment of the invention has been disclosed, it will be apparent to persons skilled in the art that modifications may be made without departing from the scope of the invention. All such modifications and equivalents thereof are intended to be covered by the following claims.

What is claimed is:

1. A planar one-way coupling for use in a geared power transmission having a transmission housing and multiple torque transmitting elements, the coupling comprising:
a circular notch plate anchored to the transmission housing;
a circular pocket plate connected to a torque transmitting element of the transmission;
the notch plate and the pocket plate having a common axis, each plate having a planar, radially-disposed annular surface, the annular surfaces being disposed in adjacent, juxtaposed relationship;
a plurality of notches in the annular surface of the notch plate, the notches being spaced about the common axis, each notch having an abutment shoulder;
a plurality of pockets in the annular surface of the pocket plate, the pockets being disposed about the common axis, each pocket having a torque reaction edge disposed in a generally radial direction and a radially outward edge;
a torque transmitting strut in each pocket, each strut having a pivotal active edge engageable with the torque reaction edge of a pocket in the pocket plate and an active edge movable about the reaction edge of a pocket outwardly toward the annular surface of the notch plate; and
a strut spring in each pocket of the pocket plate engageable with a strut, each spring urging a strut into engagement with a notch of the notch plate when relative rotary motion of the pocket plate with respect to the notch plate approaches zero, whereby the active edge of the strut engages an abutment shoulder in a notch of the notch plate;
a planar snap ring having an outer diameter and an inner diameter;
an arcuate opening in the snap ring defining two snap ring ends;
the one of the plates having an extension surrounding the other of the plates;
a snap ring groove in the one plate;
the snap ring being disposed in the snap ring groove whereby the pocket plate and the notch plate are held in assembled relationship; and
a radially outward edge of one of the snap ring ends being formed with a notch tip, the notch tip being formed substantially entirely within the snap ring groove whereby the one snap ring end can be displaced radially inward by a tool as the tool enters the snap ring groove through the arcuate opening and engages the notch tip.

2. The planar one-way coupling set forth in claim 1 wherein the one snap ring end is displaced radially inward as torque is applied by the tool.

3. The planar one-way coupling set forth in claim 2 wherein the tool is fulcrumed on the other of the snap ring ends.

4. The planar coupling set forth in claim 1 wherein the one plate is the notch plate and the other plate is the pocket plate.

5. The planar coupling set forth in claim 2 wherein the one plate is the notch plate and the other plate is the pocket plate.

6. The planar coupling set forth in claim 3 wherein the one plate is the notch plate and the other plate is the pocket plate.
